(19) United States
(12) Patent Application Publication
(10) Pub. No.: US 2019/0291059 A1
(43) Pub. Date: Sep. 26, 2019

(54) METHOD AND A STARTING MATERIAL FOR THE MANUFACTURE OF A HYDROGEN PERMEABLE MEMBRANE AND A HYDROGEN PERMEABLE MEMBRANE

(71) Applicant: OERLIKON METCO AG, WOHLEN, Wohlen (CH)

(72) Inventors: Rajiv J. DAMANI, Winterthur (CH); Arno REFKE, Fahrwangen (CH)

(73) Assignee: OERLIKON METCO AG, WOHLEN, Wohlen (CH)

(21) Appl. No.: 16/437,819

(22) Filed: Jun. 11, 2019

Related U.S. Application Data
(63) Continuation of application No. 12/191,842, filed on Aug. 14, 2008, now abandoned.

(30) Foreign Application Priority Data
Aug. 16, 2007 (EP) 07114428.1

(51) Int. Cl. B01D 71/02; C04B 35/50; B01D 67/00; B01D 69/14; C04B 35/48; C01B 3/50

(52) U.S. Cl. CPC B01D 71/024; B01D 2325/26; B01D 67/0072; B01D 69/141; B01D 71/022; C04B 35/48; C01B 3/503; C01B 3/505; C04B 2235/3225; C04B 2235/3224; C04B 2235/3215; C04B 2235/3213; C04B 2235/3208; C01B 2203/0495; C01B 2203/0485; C01B 2203/0475; C01B 2203/047; C01B 2203/0405; B01D 2256/16; Y10T 428/131; C04B 2235/3229; C04B 2235/3286; C04B 2235/3289; C04B 2235/768; B01D 2325/20; Y10T 428/31678; Y02P 30/30; C04B 35/50

(57) ABSTRACT

Method for the manufacture of a hydrogen-permeable membrane having a thickness of not greater than 30 μm. The method includes plasma spraying at least one dense layer on a porous substrate such that during the plasma spraying, one sweep of a process beam deposits material particles over the substrate in a form of individual splats which do not produce a cohesive layer and said material particles include a proton-conducting ceramic material and an electron-conducting metallic component. The plasma spraying is LPPS-TF that utilizes a spraying distance of between 200 mm and 2000 mm, a sprayable powder starting material having a particle size range between 1 and 80 μm and containing the proton-conducting ceramic material and the electron-conducting metallic component and a process beam dispersing the sprayable powder starting material to a cloud.

### CROSS-REFERENCE TO RELATED APPLICATIONS

The instant application is a continuation of U.S. non-provisional application Ser. No. 12/191,842 filed Aug. 14, 2008, which application claims priority under 35 U.S.C. § 119 of European Patent Application No. 07114428.1 filed on Aug. 16, 2007. The entire disclosures of each of these applications is herein expressly incorporated by reference.

### STATEMENT REGARDING FEDERALLY SPONSORED RESEARCH OR DEVELOPMENT

Not applicable.

### REFERENCE TO A COMPACT DISK APPENDIX

Not applicable

### BACKGROUND OF THE INVENTION

The invention relates to a method for the manufacture of a hydrogen permeable membrane in accordance with the pre-characterising part of the independent method claim and to a starting material for this method and further to a hydrogen permeable membrane.

Hydrogen permeable membranes are layers which have a high selective permeability for hydrogen and are substantially impermeable for other gases. Accordingly such membranes are used to extract hydrogen from gas or fluid mixtures.

Global environmental demands and the short supply of oil reserves have led to huge efforts being made to develop other methods of the production of electrical energy, and also to develop viable alternatives with respect to ecological and economic aspects in the transport field to classic combustion engines which work with petroleum based fuels. Important issues here are the reduction of the emission of environmentally harmful materials such as carbon dioxide for example and energy generation from re-generative sources.

Hydrogen is attributed with a large significance in these developments not only with regard to the production of electrical energy but also in the field of transport. However hydrogen is also needed in many other chemical processes, for example in the manufacture of liquid hydrocarbons using to the Fischer-Tropsch method, in the direct liquefaction of coal or in the oil refinery.

On the other hand there are many processes in which hydrogen occurs, for example in the combustion of oil or gas based materials and in steam reforming or catalytic reforming. However, in this connection the hydrogen occurs together with other gases or combustion gases, for example in combination with carbon dioxide and must therefore be first extracted from the gas mixture first in order that it can be used.

In this connection membranes are known among other things, which are selectively permeable for hydrogen. On the one hand there are metallic membranes which have a high selective permeability for hydrogen. On the other hand ceramic membranes are known, which comprise oxides of the perovskite type, for example BACe₁₋ₓMₓO₃, wherein M designates a doped metal such as Y. These ceramic membranes are ionic conductors and have a high proton conductivity for example. However their electron conductivity is generally not adequate to achieve sufficiently large hydrogen flow rates for industrial applications.

Therefore composite membranes have been proposed which contain not only a proton conducting ceramic component but also a good electron conducting metallic component. Membranes of this kind are also termed Cermet membranes (CERamic METal). Such two-phase hydrogen permeable membranes are described for example in U.S. Pat. No. 6,235,417 or in U.S. Pat. No. 6,235,417. For the manufacture of the membranes U.S. Pat. No. 6,235,417 for example discloses the coating of a suitable ceramic powder with palladium by means of chemical deposition from the vapour phase (CVD chemical vapour deposition) or the wet impregnation of the ceramic powder with a palladium chloride solution and subsequent drying, calcining, pressing and sintering.

Starting from the prior art, it is an object of the invention to propose another method for the manufacture of a hydrogen permeable membrane which includes a proton conducting ceramic material and an electron conducting metallic component. The membrane should possess a high proton and electron conductivity, so that suffident hydrogen flow rates can be achieved. Further, by means of the invention a starting material should be proposed for this method and a corresponding hydrogen permeable membrane.

### BRIEF SUMMARY OF THE INVENTION

The subjects of the invention satisfying this object are characterised by the independent claims in the respective category.

In accordance with the invention a method is thus proposed for the manufacture of a hydrogen permeable membrane which includes a proton conducting ceramic material and an electron conducting metallic component. The membrane is deposited on a substrate by means of plasma spraying, wherein a starting material is sprayed onto a surface of the substrate in the form of a process beam, with the starting material being injected into a plasma at a low process pressure, which is 10 000 Pa at the most, said plasma defocussing the process beam and said starting material being melted partly or completely there.

Surprisingly it has been shown that by means of such a plasma spraying method, with which very dense and thin layers can be produced on the substrate, a hydrogen permeable membrane can be produced the proton conductivity and electron conductivity of which is so great that with them considerable flow rates for hydrogen of, for example, more than 10 millilitre per minute and square centimetre can be achieved.

A plasma spraying method is preferably used in which in comparison with conventional plasma spraying methods a very long plasma flame is generated. The spraying distance between an outlet nozzle for the process beam and the substrate then amounts to at least 200 mm and preferably to at least 400 mm. As a result the dwell time of the material in the plasma flame is increased considerably, resulting in a higher energy transfer of plasma to the material, which has a very favourable effect on the formation of a thin and dense layer on the substrate.

The ceramic material is preferably an oxide of the perovskite type because these have proved to be very good proton conductors in practice.

It is particularly preferable when the ceramic material of the perovskite type has the form ABO₃, wherein A is selected from the group which consists of barium (Ba), calcium (Ca), magnesium (Mg) and strontium (Sr) and B has the form CeₓZr_{y}M_{1-x-y} whereby x and y are respectively smaller than or equal to 1 and larger than or equal to zero and M is selected from the group which consists of yttrium (Y), ytterbium (Yb), europium (Eu), gadolinium (Gd), indium (In), neodymium (Nd), thulium (Tm), holmium (Ho), rhodium (Rh), samarium (Sm), titanium (Ti) and scandium (Sc). This means the component B of the perovskite like ceramic is preferably either only cerium or only zirconium or a mixture of zirconium and cerium. The latter can be realised for example by a solid solution of BaZrO₃ and BaCeO₃.

The metallic component is preferably one of the metals: palladium (Pd), vanadium (V), niobium (Nb), tantalum Ta) or zirconium (Zr) or an alloy of at least one of these metals. Tantalum has proved to be of particular value. The electron conductivity of the membrane can be considerably improved by this metallic component. Palladium alloys, especially with gold (Au), copper (Cu) or silver (Ag) or also tantalum alloys have proved to be of particular value.

In order to realise particularly dense layers it has proved advantageous when the process pressure in the plasma spraying method amounts to at least 10 Pa and preferably 50 Pa to 1000 Pa.

The total flow rate of the process gas in plasma spraying is preferably less than 200 SLPM (standard litre per minute) and particularly preferably amounts to 60 to 80 SLPM.

As regards the supply rates of the powdered starting material it has proved favourable in practice when a supply rate is selected of from 10 to 200 g/min, preferably of 40-120 g/min.

The starting material in accordance with the invention for the manufacture of a hydrogen permeable membrane in accordance with the method of the invention contains a proton conducting material and an electron conducting metallic component. This starting material is a powder or a powder mixture, either of which can be deposited on a substrate by means of plasma spraying.

In the same way as has been explained for the method in accordance with the invention the ceramic material of the starting material is an oxide of the perovskite type.

In the starting material, the ceramic material of the perovskite type preferably has the form ABO₃, wherein A is selected from the group which consists of barium (Ba), Calcium (Ca), magnesium (Mg) and strontium (Sr) and B has the form CeₓZr_{y}M_{1-x-y} whereby x and y are respectively smaller than or equal to 1 and larger than or equal to zero and M is selected from the group which consists of yttrium (Y), ytterbium (Yb), europium (Eu), gadolinium (Gd), indium (In), neodymium (Nd), thulium (Tm), holmium (Ho), rhodium (Rh), samarium (Sm), titanium (Ti) and scandium (Sc).

In the case of the starting material the metallic component of one of the metals is preferably palladium (Pd), vanadium (V), niobium (Nb), tantalum Ta) or zirconium (Zr) or an alloy of at least one of these metals. This is particularly preferably a palladium alloy, tantalum or a tantalum alloy.

A hydrogen permeable membrane is further proposed by the invention which is manufactured in accordance with a method of the invention or from a starting material in accordance with the invention.

A substrate with a hydrogen permeable membrane in accordance with the invention is further proposed wherein the substrate is in particular plate-like or tubular. The planar plate-like shape of the substrate is characterised in particular by the simple manufacture, whereas the tubular design has the advantage of a particularly large membrane surface relative to the volume enclosed.

Further advantageous measures and preferred designs of the invention result from the dependent claims.

### BRIEF DESCRIPTION OF THE DRAWINGS

The invention will be explained more closely in the following with the help of the embodiments and with the help of the drawings. In the schematic drawings there is shown, partly in section:

FIG. 1 a schematic illustration of an apparatus for the carrying out of a method in accordance with the invention,

FIG. 2 a very schematic sectional view of an embodiment of a hydrogen permeable membrane in accordance with the invention on a panel-shaped substrate,

FIG. 3 a schematic illustration of a two adjacent splats in the layer of FIG. 2, and

FIG. 4 a schematic sectional view of an embodiment of a hydrogen permeable membrane in accordance with the invention on a tubular substrate.

### DETAILED DESCRIPTION OF THE INVENTION

The method in accordance with the invention for the manufacture of a membrane selectively permeable for hydrogen, which includes two phases, namely a proton conducting ceramic material and an electron conducting metallic component, is in particular characterised in that the membrane is generated by means of a plasma spraying process with which a dense microstructure can be produced.

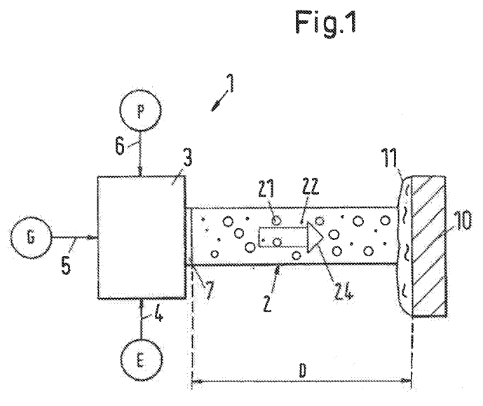

FIG. 1 shows in a very schematic illustration a plasma spraying apparatus which is designated as a whole by the reference numeral 1 and which is suitable for the carrying out of a method in accordance with the invention. Moreover, in FIG. 1, a substrate 10 is schematically illustrated on which a hydrogen permeable membrane is deposited in the form of a layer 11.

The method in accordance with the invention preferably includes a plasma spraying process of the kind described in WO-A-03/087422 or also in U.S. Pat. No. 5,853,815. This plasma spraying process is a thermal spraying process for the manufacture of a so-called LPPS thin film (LPPS=low pressure plasma spraying).

An LPPS thin film process (LPPS-TF=LPPS thin film) is specially carried out with the plasma spraying apparatus 1 shown in FIG. 1. In this a conventional LPPS plasma spraying method is technically modified method-wise in that a space through which plasma is flowing (“plasma flame” or “plasma beam”) is enlarged due to the modifications and extended to a length of up to 25 metres. The geometrical extension of the plasma leads to a uniform enlargement—a “defocusing”—of a plasma beam, which is injected into the plasma with a feed gas. The material of the process beam, which disperses to a cloud in the plasma and is fully or partially melted there, reaches the surface of the substrate 10 uniformly distributed.

The plasma spraying apparatus 1 illustrated in FIG. 1 includes a plasma generator 3 known, per se with a plasma torch for the production of a plasma which is not illustrated in detail. Using the plasma generator 3 a process beam 2 is produced in a manner known per se from a starting material P, a process gas mixture G and electrical energy E. The feeding in of these components E, G and P is symbolised in FIG. 1 by the arrows 4, 5, 6. The process beam 2 produced emerges through an outlet nozzle 7 and transports the starting material P in the form of the process beam 2 in which material particles 21, 22 are dispersed in a plasma. This transport is symbolised by the arrow 24. The different material particles 21, 22 are intended to indicate that at least a ceramic material 21 and also a metallic component 22 are contained in the process beam 2. As a rule the material particles 21, 22 are powder particles. The morphology of the layer 11 deposited on the substrate 10 is dependent on the process parameters and in particular on the starting material P, the process enthalpy and the temperature of the substrate 10.

In the case of the LPPS-TF process described here the starting material P is injected into a plasma defocusing the material beam at a low process pressure which is 10 000 Pa at the most and preferably 1000 Pa at the most and is partly or completely melted therein or at least made plastic. For this purpose a plasma is produced with sufficiently high specific enthalpy, so that a very dense and thin layer 11 arises on the substrate. The variations of the structure are substantially influenced and controllable by the coating conditions, in particular by process enthalpy, working pressure in the coating chamber and also the process beam. Thus the process beam 2 has characteristics which are determined by controllable process parameters.

For the manufacture of the hydrogen permeable membrane the layer 11 is produced in such a way that it has a very dense microstructure which will be explained further on.

First of all the method step of the production of the layer 11 by means of LPPS-TF will now be explained more closely.

A powder of suitable composition is selected as starting material P, such as will be described further on. In this connection it is a possibility that the starting material P is present in the form of a single powder, which contains not only the ceramic material but also the metallic component. Another possibility is that of using two different materials in powder form as the starting material, of which one contains the ceramic material and the other contains the metallic component. These two materials can either be injected into the plasma flame simultaneously via two different powder inlets or also one after the other with regards to time.

As has already been mentioned, in the LPPS-TF method the plasma flame is very long due to the adjusted process parameters in comparison with conventional plasma spraying processes. Moreover, the plasma flame is considerably widened. A plasma with a high specific enthalpy is produced, through which a high plasma temperature results. Due to the high enthalpy and the length and/or the size of the plasma flame, a very high energy input into the material particles 21, 21 arises which are thereby, on the one hand, strongly accelerated and, on the other hand, brought to a high temperature, so that they are readily melted and are also still very hot after their deposition on the substrate 10. Since, on the other hand, the plasma flame and thus the process beam 2 is very greatly broadened, the local heat flow into the substrate 10 is slight, so that a thermal damaging of the material is avoided. The broadened plasma flame has the further consequence that usually, with a single sweep of the process beam 2 over the substrate 10, the material particles 21, 22 are deposited in the form of individual splashes (splats), which do not produced any continuous i.e. cohesive layer. By this means very thin layers 11 can be generated. The high kinetic and thermal energy which the material particles receive in their long residence in the plasma flame in comparison to conventional plasma methods, favours the formation of a very dense layer 11, which in particular has few boundary surface cavities between splats lying one on top of the other.

The plasma is produced for example in a plasma torch known per se in the plasma generator 3 with an electrical direct current and by means of a pin cathode and a ring-shaped anode. The energy supplied to the plasma, the effective energy can be determined empirically with relation to the resulting layer structure. The effective energy which is given by the difference between the electrical energy and the heat given off by the cooling, lies, as experience has shown, in the range of 40 to 80 kW for example. In this connection it has proved valuable when the electrical current for the plasma production lies between 1000 and 3000 A, in particular between 1500 and 2600 A.

A value between 10 and 10000 Pa, preferably between 100 and 1000 Pa is selected in the process chamber for the process pressure of the LPPS-TF plasma spraying for the production of the hydrogen-permeable membrane.

The starting material P is injected into the plasma as a powder beam with a feed gas, preferably argon or a helium argon mixture. The flow rate of the feed gas preferably amounts to 5 to 40 SLPM (standard litres per minute), in particular to 10 to 25 SLPM.

The process gas for the production of the plasma is preferably a mixture of inert gases, in particular a mixture of argon Ar, hydrogen H and helium He. In practice the following gas flow rates for the process gas have proved particularly valuable:

Ar flow rate: 30 to 150 SLPM, in particular 50 to 100 SLPM

H₂ flow rate: zero to 20 SLPM, in particular 2 to 10 SLPM

He flow rate: zero to 150 SLPM, in particilar 20 to 100 SLPM,

wherein the total flow rate of the process gas is preferably smaller than 200 SLPM and in particular amounts to 60 to 180 SLPM.

The powder supply rate with which the starting material P is supplied, lies between 10 and 200 g/min in particular, preferably between 40 and 120 g/min.

It can be advantageous when the substrate is moved with rotating or swinging movements relative to this cloud during the material application. It is naturally also possible to move the plasma generator 3 relative to the substrate 10.

The spraying distance, i.e. the distance D between the outlet nozzle 7 and the substrate 10 preferably amounts to 200 to 2000 mm and in particular to 400 to 1000 mm.

The hydrogen permeable membrane is built up by means of this plasma spraying—typically by the deposition of a plurality of layers. By this means the densest possible structure and a thin layer is produced.

The total layer thickness of the membrane typically amounts to 30 μm at the most. Values of the layer thickness of 5 μm to 10 μm are preferred.

So that the material particles 21, 22 readily melt in the process beam 2 and receive a high thermal and kinetic energy, in order to produce the layer 11 with the dense structure, the starting material in powder form P is advantageously very fine grained. The size distribution of the powder particles in the starting material P is determined by means of a laser scattering method. It is advantageously the case for this size distribution that a substantial part of it lies substantially in the range between 1 and 80, preferably between 5 μm and 45 μm.

Various methods can be used for the manufacture of the powder particles: for example spray drying or a combination of melting and subsequent crushing and/or grinding of the solidified melt.

The starting material P is preferably present in the form of a mixture (blend). This powder mixture contains a proton-conducting ceramic material and the metallic component. The ceramic material is preferably an oxide of the perovskite type and has the form ABO₃. In this connection A designates an element which is selected from the group which consists of barium (Ba), calcium (Ca), magnesium (Mg) and strontium (Sr). B has the form CeₓZr_{y}M_{1-x-y} whereby x and y are respectively smaller than or equal to 1 and larger than or equal to zero and M is selected from the group which includes yttrium (Y), ytterbium (Yb), europium (Eu), gadolinium (Gd), indium (In), neodymium (Nd), thulium (Tm), holmium (Ho), rhodium (Rh), samarium (Sm), titanium (Ti) and scandium (Sc). In this connection x and y can also take on the value zero, wherein however x and y do not both have the value zero at the same time. I.e. the element B can either contain both of the elements Ce and Zr or only one of the two elements Ce and Zr. The added element M is preferably contained in B in a proportion of 0.4 at most, i.e. 1−x−y is smaller or equal to 0.4.

A crucial aspect under which the specific composition of the ceramic components is selected is a very good, or very high proton conductivity. The ceramic components can, for example have the following compositions:

| | |
|---|---|
| BaCe_{0.8}Gd_{0.2}O₃ | BaCe_{0.95}Y_{0.05}O₃ |
| BaCe_{0.9}Nd_{0.1}O₃ | BaCe_{0.95} Gd_{0.05}O₃ |
| SrCe_{0.95}Tm_{0.05}O₃ | BaZr_{0.95}Rh_{0.05}O₃ |
| SrCe_{0.95}Y_{0.05}O₃ | SrZr_{0.95}Yb_{0.05}O₃ |
| SrCe_{0.95}Ho_{0.05}O₃ | SrCe_{0.95}Y_{0.05}O₃ |
| SrZr_{0.5}Y_{0.05}O₃ | SrCe_{0.95}Sc_{0.05}O₃ |
| CaZr_{0.9}In_{0.1}O₃ | BaCe_{0.85}Eu₀₁₅O₃ |
| BaCE_{0.5}Zr_{0.4}Y_{0.1}O₃ | BaCe_{0.6}Zr₀₂Y_{0.2}O₃ |

In addition to the ion conductivity, especially the proton conductivity, the ceramic components should also exhibit mechanical strength or stability, in order to then serve as a framework in particular which supports the membrane and prevents a creeping of the material.

The electron conducting metallic component is a preferred embodiment of a palladium (Pd) alloy and especially a palladium-gold alloy, a palladium-copper alloy or a palladium-silver alloy. Pd alloys have a good selective permeability for hydrogen in atomic form and, moreover, have a very good electronic conductivity. Further preferred materials for the metallic components are vanadium (V), niobium (Nb), tantalum (Ta), zirconium (Zr) or an alloy which contains at least one of these metals. Tantalum or a tantalum alloy are further particularly preferred as a metallic component.

In addition to the electron conductivity, the object of the metallic components is further to give the membrane ductility and a good permeability for atomic or ionic hydrogen.

The choice of suitable partners for the ceramic material on the one hand and the metallic components on the other hand, takes place having regard to the thermal characteristics of the two partners. Since hydrogen permeable membranes are often used at operating temperatures of 650° C. to 900° C., the thermal characteristics should suit each other in such a way that a reciprocal disintegration does not result, for example through extremely differing thermal expansions.

The hydrogen permeable membrane should further also be chemically stable in the long term, especially in reducing environments, for example in environments which contain CO₂, H₂O, CO or sulphur—to name only a few examples.

Depending on the application case a further aspect in the selection of suitable ceramic and metallic components is that the membranes also have to be chemically stable in cyclically changing, reducing and oxidising atmospheres.

It will be understood that a plurality of different ceramic materials and/or a plurality of different electron conducting metallic components can also be used for the manufacture of the hydrogen permeable membrane.

The proton conducting ceramic material and the electron conducting metallic components are used as a starting material P for the plasma spraying. A possibility exists in making available the ceramic material and the metallic components in the form of a powder mixture (blend), which can be processed in the plasma spraying process. As already mentioned, in this connection the size distribution of the particles in the powder for the LPPS-TF process should be such that a large part of it lies substantially in the range between 1 μm and 80 μm. Methods known per se, such as spray drying for example, are suitable for the manufacture of the starting material in powder form.

If, as a ceramic component, one is selected in which both cerium and also zirconium are contained in the component B of the compound ABO₃, then this ceramic component can be manufactured by a solid solution of BaZrO₃ and BaCeO₃, which is then further doped with one of the elements M.

For the manufacture of a starting material P, which contains both the ceramic component and also the metallic component, it is also possible to coat the ceramic material in powder form with the metallic component (cladding), so that the individual ceramic particles or agglomerates thereof are wholly or partially provided with a metallic layer.

It is naturally also possible to introduce the ceramic material and the metallic components into the LPPS-TF process separately from one another and/or one after the other.

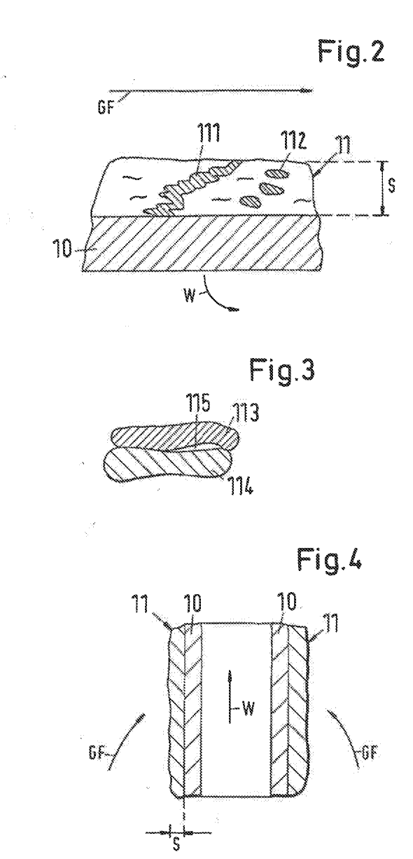

FIG. 2 shows in a schematic sectional view an embodiment of a hydrogen permeable membrane in accordance with the invention which is applied to a plate-shaped substrate 10 as a layer 11 and which is manufactured according to an embodiment of the method in accordance with the invention. The membrane has two phases, namely a ceramic phase and a metallic phase. This combination of materials is usually termed a cermet. The membrane has a layer thickness S, which lies between 5 μm and 20 μm.

As schematically indicated in FIG. 2, the metallic component in the layer 11 forms migration or trickle paths 111, 112 which considerably increase the electron conductivity of the layer 11. These paths can extend completely through the layer 11, as the path 111 schematically shows. It is however also possible, as shown by the path 112, that that these paths are not continuous, in other words do not extend all the way from the substrate 10 to the surface of the layer 11, which faces away from the substrate. Such paths which are not continuous also increase the electron conductivity of the layer 11, i.e. of the membrane.

As already mentioned, very dense layers can be produced using the method in accordance with the invention. FIG. 3 demonstrates this, which shows a schematic illustration of two adjacent splashes (splats) 113, 114 in the layer 11 from FIG. 2. The material particles in the process beam 2 receive a very high kinetic and thermal energy, in particular due to a high specific enthalpy of the plasma. The specific enthalpy of the plasma can for example lie in the process pressure range below 1000 Pa in the range of 10,000 to 15,000 kj/kg and in the process pressure range of 10,000 Pa at 3,000 to 4,000 kj/K. The contact surfaces between adjacent splats 113, 114 are considerably increased by the high kinetic and thermal energy of the particles. As shown by FIG. 3, the adjacent splats 113, 114 typically do not touch each other across the total area of their confronting surfaces, but rather boundary surface cavities 115 form between adjacent splats 113, 114. In conventional thermal spraying processes the proportion of the contact surfaces with which adjacent splats touch each other, usually lies at approximately 30% of the surfaces of the adjacent splats facing each other, i.e. approximately 70% of the surface of adjacent splats bound or form boundary surface cavities 115. It is possible with the method in accordance with the invention to reduce these boundary surface cavities 115 considerably, or to considerably increase the contact surfaces with which the adjacent splats 113, 114 touch each other. In the method in accordance with the invention, the proportion of the contact surface between adjacent splats 113, 114 or the layers 11 manufactured therewith amounts for example to at least 50% of the confronting surfaces of the adjacent splats 113, 114 and preferably amount to at least 70%.

In order to increase the proportion of the contact surface even more it can be advantageous to sinter the layer 11 or the membrane after its manufacture, advantageously at 800° C. to 1200° C. In this way a subsequent compaction and elimination of faults can be achieved.

The substrate 10 (see-FIG. 2) onto which the layer 11 is applied, can also be a ceramic material for example. The substrate 10 consists of a porous material which is essentially completely gas permeable, which has an adequate mechanical stability and which can also withstand process temperatures of 650° C. to 1000° C. The substrate 10 can further withstand pressure differences of some tens of bar (some MPa), for example 30 MPa. This is advantageous because the diffusion based transport of the hydrogen is driven by the metallic component of the membrane, by the pressure difference, i.e. the partial pressure difference over the membrane.

In the operating state the gas mixture (arrow GF in FIG. 2) from which the hydrogen is to be extracted, flows on one side of the membrane. Only the hydrogen contained in the gas mixture FG is able to penetrate the membrane, as indicated by the arrow W and is able to be led away on the other side of the membrane. Depending on the process it can be advantageous in this connection, if the gas mixture GF flows at an elevated pressure.

The high selective permeability for hydrogen is due to the high proton conductivity of the ceramic material and to the hydrogen diffusion, which is made possible by the metallic component. At a layer thickness S of 5 μm to 20 μm for example, through flow rates for the hydrogen of at least 10 millilitres per minute and square centimetre can be achieved using the hydrogen permeable membrane in accordance with the invention.

In comparison with one phase structures, which only comprise a proton conducting oxide of perovskite type, the proton conductivity of the two-phase structure is considerably higher, which results from the electronic conductivity of the metallic phase.

An embodiment of a hydrogen permeable membrane in accordance with the invention is shown in FIG. 4 in a schematic sectional view, wherein the membrane is provided on a tubular substrate. Otherwise the explanations relating to FIG. 2 apply in the same way. The layer 11 with the dense structure forming the membrane is provided on the outside of the tubular substrate in order to have as large a surface as possible available for the membrane. The gas mixture GF is preferably introduced from the outside and under pressure to the tubular substrate 10 with the layer 11. The hydrogen penetrates the membrane and can be led away inside the tubular substrate, as the arrow W indicates.

It is, for example, also possible to arrange a plurality of such tubular substrates 10, which are each provided with a hydrogen permeable membrane, in a process chamber, which are then filled with the gas mixture GF and put under pressure. The extracted hydrogen can then be led away through the inside of the tubular substrate.

It is further possible to intentionally modify the surface of the layer 11 in a manner known per se, in order to achieve a catalytic action.

In the manufacture of the layer 11 by means of a LPPS-TF method, the specific enthalpy of the plasma is adjusted in dependence on the process pressure.

In a first example the process pressure amounts to 1.5 mbar (150 Pa), an argon/helium mixture is used as plasma gas. The current for the production of the plasma amounts to 1900-2600 A. The gas flow takes place in the ultrasonic range at a speed of 2800-3300 m/s (Mach number 1.5-3). The plasma temperature amounts to 8 000 K to 10 000 K. The specific enthalpy is measured on the axis of the plasma flame at a distance of 400 mm to 1000 mm from the outlet nozzle 7 of the plasma spraying apparatus 1. This corresponds to a typical spraying distance, in which the substrate 10 to be sprayed is located. The specific enthalpy of the plasma amounts to 10 000 to 15 000 kJ/kg. The local heat flow is comparatively slight at 4 MW/m². The plasma characteristics on the axis are essentially constant in the range of 300 to 1000 mm distance from the outlet nozzle 7.

In a second example the process pressure amounts to 100 mbar (10 000 Pa), an argon/helium mixture is used as a plasma gas. The current for the production of the plasma amounts to 1500-2600 A. The gas flow is largely below the speed of sound at a speed of 200-800 m/s (Mach number 0.4-0.8). The plasma temperature amounts to 2 000 K to 4000 K. The specific enthalpy is measured on the axis of the plasma flame at a distance of 300 mm to 400 mm from the outlet nozzle 7 of the plasma spraying apparatus 1. This corresponds to a typical spraying distance, in which the substrate 10 to be sprayed is located. The specific enthalpy of the plasma amounts to 3 000 to 4 000 kJ/kg. The local heat flow is still slight at 5-16 MW/m². The plasma characteristics along the axis are not constant: they fall from a maximum to a minimum between 300 mm and 400 mm.

In a third example the process pressure amounts to 1.5 mbar (150 Pa), an argon/hydrogen mixture is used as a plasma gas. The current for the production of the plasma amounts to 1500 A. The gas flow is located in the supersonic range at a speed of 3000 m/s (Mach number 2 to 3). The plasma temperature amounts to 8000 K. The specific enthalpy is measured on the axis of the plasma flame at a distance of 300 mm to 1000 mm from the outlet nozzle 7 of the plasma apparatus 1. This corresponds to a typical spraying distance in which the substrate to be coated 10 is located. The specific enthalpy of the plasma amounts to 15 000 kJ/kg. The local heat flow is comparatively slight at 5 MW/m². The plasma characteristics in the range of 300 mm to 1000 mm distance from the outlet nozzle 7 are essentially constant.

What is claimed:

1. A method for the manufacture of a hydrogen-permeable membrane having a thickness of not greater than 30 μm, comprising:
plasma spraying at least one dense layer on a porous substrate such that during the plasma spraying, one sweep of a process beam deposits material particles over the substrate in a form of individual splats which do not produce a cohesive layer and said material particles include a proton-conducting ceramic material and an electron-conducting metallic component,
wherein the plasma spraying is a low pressure plasma spraying thin film (LPPS-TF) process that utilizes:
a spraying distance defined between an outlet nozzle and the substrate that is between 200 mm and 2000 mm;
a sprayable powder starting material having a particle size range between 1 and 80 μm and containing the proton-conducting ceramic material and the electron-conducting metallic component; and
a process beam dispersing the sprayable powder starting material to a cloud,
wherein said membrane has a hydrogen flow rate greater than 10 milliliters per minute and square centimeter.

2. The method of claim 1, wherein the proton-conducting ceramic material is an oxide of the perovskite type.

3. The method of claim 2, wherein the ceramic material of the perovskite type has the form ABO₃, wherein A is selected from the group which consists of barium (Ba), Calcium (Ca), magnesium (Mg) and strontium (Sr) and B has the form CeₓZr_{y}M_{1-x-y}, whereby x and y are respectively smaller than or equal to 1 and larger than or equal to zero and M is selected from the group which consists of yttrium (Y), ytterbium (Yb), europium (Eu), gadolinium (Gd), indium (In), neodymium (Nd), thulium (Tm), holmium (Ho), rhodium (Rh), samarium (Sm), titanium (Ti) and scandium (Sc).

4. The method of claim 1, wherein the electron-conducting metallic component is of one of; palladium (Pd), vanadium (V), niobium (Nb), tantalum (Ta), zirconium (Zr), or an alloy of at least one of: Pd, V, Nb, Ta, Zr.

5. The method of claim 1, wherein the plasma spraying utilizes a process pressure of one of:
at least 10 Pa; and
between 50 Pa and 1000 Pa.

6. The method of claim 1, wherein the plasma spraying utilizes a process gas flow rate of one of:
less than 200 SLPM; and
between 60 SLPM and 180 SLPM.

7. The method of claim 6, wherein the method utilizes a starting material supply rate that is one of:
between 10 to 200 g/min; and
between 40 to 120 g/min.

8. The method of claim 1, wherein said membrane has a thickness of between 5 μm and 20 μm.

9. The method of claim 1, wherein the electron-conducting metallic component in the at least one layer is arranged to form one of:
migration paths; and
trickle paths.

10. A method for the manufacture of a hydrogen-permeable membrane, comprising:
plasma spraying, via low pressure plasma spraying thin film (LPPS-TF) process, at least one dense layer on a porous substrate, said at least one layer comprising a proton-conducting ceramic material and an electron-conducting metallic component; and
said plasma spraying forming the at least one layer by sweeping a process beam across the substrate with one sweep of the process beam forming individual splats which do not produce a cohesive layer,
wherein the plasma spraying utilizes a sprayable starting material powder having a particle size of between 1 μm and 80 μm and that contains the proton-conducting ceramic material and the electron-conducting metallic component;
wherein the plasma spraying utilizes a process beam dispersing the sprayable starting material powder to a cloud,
wherein the proton-conducting ceramic material is an oxide of the perovskite type,
wherein the electron-conducting metallic component in the at least one layer is arranged to form one of migration paths and trickle paths that increase electron conductivity of the at least one layer,
wherein said membrane has a hydrogen flow rate greater than 10 milliliters per minute and square centimeter.

11. A method for the manufacture of a hydrogen-permeable membrane having a hydrogen flow rate greater than 10 milliliter per minute and square centimeter, comprising:
plasma spraying at least one dense layer on a porous substrate, said at least one layer comprising a proton-conducting ceramic material and an electron-conducting metallic component,
wherein the proton-conducting ceramic material is an oxide of the perovskite type,
wherein the at least one layer:
is deposited by sweeping a plasma beam over the substrate such that one sweep of the plasma beam forms individual splats over the substrate; and
includes therein migration paths and trickle paths that increase electron conductivity of the at least one layer and contain the electron-conducting metallic component, and
wherein the plasma spraying is a low pressure plasma spraying thin film (LPPS-TF) process and the plasma spraying utilizes:
a sprayable starting material having a particle size of between 1 μm and 80 μm; and
a spraying distance defined between an outlet nozzle and the substrate that is between 200 mm and 2000 mm.

12. The method of claim 11, wherein the plasma spraying further utilizes a spraying distance defined between an outlet nozzle and the substrate that is between 200 mm and 2000 mm.
